(19) United States
(12) Patent Application Publication
(10) Pub. No.: US 2022/0286813 A1
(43) Pub. Date: Sep. 8, 2022

(54) LOCATION DETERMINATIONS OF ELECTRONIC DEVICES

(71) Applicant: Hewlett-Packard Development Company, L.P., Spring, TX (US)

(72) Inventors: Jiaqi Zou, Houston, TX (US); Alexander Wayne Clark, Spring, TX (US)

(73) Assignee: Hewlett-Packard Development Company, L.P., Spring, TX (US)

(21) Appl. No.: 17/636,057

(22) PCT Filed: Oct. 25, 2019
(86) PCT No.: PCT/US2019/058184

§ 371 Date: Feb. 17, 2022

(51) Int. Cl. H04W 4/029; H04W 4/02; H04W 4/30; H04L 67/306

(52) U.S. Cl. CPC H04W 4/029; H04W 4/027; H04W 4/30; H04L 67/306

(57) ABSTRACT

In some examples, an electronic device, comprises a sensor to output motion data indicating movement of the electronic device; a storage device storing a device profile; and a processor coupled to the sensor and the storage device, the processor to: receive the motion data; calculate a current location of the electronic device based on the motion data and the device profile; calculate an error value based on the current location; and update the device profile based on the error value.

### BACKGROUND

Some electronic devices allow for the tracking of their locations. For example, an electronic device may contain sensors (e.g., accelerometers, gyroscopes, magnetometers, receivers (e.g., Global Positioning System (GPS))) to sense movement of the electronic device. A processor of the electronic device may use the sensed movement to determine the current location of the electronic device.

### BRIEF DESCRIPTION OF THE DRAWINGS

Various examples will be described below referring to the following figures:

FIG. 1 is a schematic diagram of an electronic device, in accordance with various examples;

FIG. 2 is a schematic diagram of a computer-readable medium storing machine-readable instructions in an electronic device, in accordance with various examples;

FIG. 3 is a schematic diagram of an electronic device, in accordance with various examples;

FIG. 4 is a conceptual diagram of a device profile of an electronic device, in accordance with various examples;

FIG. 5 is a lookup table illustrative of user profiles available in a device profile of an electronic device, in accordance with various examples; and

FIG. 6 is a lookup table illustrative of data available in a device profile of an electronic device, in accordance with various examples.

### DETAILED DESCRIPTION

As explained above, electronic devices (e.g., mobile devices, smartphones, laptops, notebooks, tablets) have the ability to determine their locations. Such location information may be helpful in navigating a user to a desired destination. For example, a user may be traveling to visit a new friend or interview for a new job. With the assistance of the electronic device, the user may be able to determine a current location of the electronic device and use mapping capabilities of the electronic device to plot a course to her destination.

In some cases, a user may be new to a building and desire to locate a destination (e.g., a meeting room, an office). However, determining a current location within the building (e.g., using GPS) may be difficult due to weak or no signals. Additionally, although a method such as dead reckoning may use sensor data to determine a current location within the building, the resulting location may be incorrect due to measurement errors attributable to environmental factors (e.g., temperature, lighting conditions, mechanical stresses on the device, etc.). The inability to determine a current location within a building may prevent the electronic device from mapping a path to the destination (e.g., the conference room).

This disclosure describes various examples of an electronic device utilizing dead reckoning (or similar techniques) to determine a current location of the electronic device based on measured data and storing a device profile usable to compensate for possible measurement errors or insufficient signal coverage. For instance, the device profile may contain data on network availability, signal strength of network connections, and a current date and time. In further examples, the device profile may contain a user profile containing information on the user's previous routes traveled within a structure (e.g., office to bathroom, security checkpoint to meeting room, office to common area, etc.). By considering the additional data of the device profile in combination with a Kalman filter (or similar technique), the electronic device increases the accuracy with which it determines its current location.

In one example in accordance with the present disclosure, an electronic device is provided. The electronic device includes a sensor to output motion data indicating movement of the electronic device; a storage device storing a device profile; and a processor coupled to the sensor and the storage device. The processor is to receive the motion data; calculate a current location of the electronic device based on the motion data and the device profile; calculate an error value based on the current location; and update the device profile based on the error value.

In another example in accordance with the present disclosure, a non-transitory computer-readable medium to store machine-readable instructions is provided. When executed by a processor of an electronic device, the machine-readable instructions cause the processor to receive motion data indicating movement of the electronic device; receive a device profile; calculate a bias factor based on the motion data and the device profile; calculate a current location of the electronic device based on the motion data and the bias factor; determine an error value based on the current location and the device profile; and update the device profile based on the error value.

In yet another example in accordance with the present disclosure, an electronic device is provided. The electronic device includes an inertial measurement device to output inertial data pertaining to the electronic device; a storage device comprising a device profile usable to model a user behavior, the device profile comprising multiple user profiles; and a processor coupled to the inertial measurement device and the storage device. The processor is to receive the inertial data; calculate a current location of the electronic device based on the inertial data; calculate an error value based on the current location and the device profile; and update the device profile based on the error value.

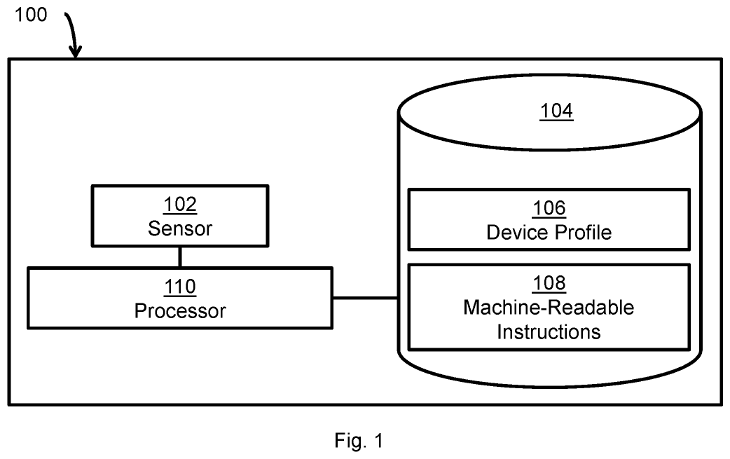

FIG. 1 is a schematic diagram of an electronic device 100 in accordance with various examples. The electronic device 100 comprises a sensor 102, a storage device 104, and a processor 110 coupled to the sensor 102 and the storage device 104. For example, the electronic device 100 may be a laptop computer, a notebook computer, a tablet, a smartphone, a mobile device, or any other suitable device. For example, the processor 110 may comprise a microprocessor, a microcomputer, a microcontroller, or another suitable embedded processor or embedded controller. For example, the sensor 102 may include an accelerometer, a gyroscope, a magnetometer, a barometer, an inertial measurement device (e.g., an inertial measurement system (IMS), an inertial measurement unit (IMU)), a receiver (e.g., GPS), another suitable type of sensor, or a combination thereof. In some examples, the sensor 102 represents multiple sensors. For example, the storage device 104 may include a hard drive, solid state drive (SSD), flash memory, random access memory (RAM), or other suitable memory. The storage device 104 may include a device profile 106 and machine-readable instructions 108. As used herein, the device profile 106 is relationship information that describes data that affects a calculation of a location. In some examples, the device profile 106 is implemented as a data structure storing data that affects a calculation of a location (e.g., information about the electronic device 100, information about the location, information about a user, information about previously calculated locations and destinations). As used herein, a data structure is an object that stores and cross-references data (e.g., a lookup table or database). In some examples, the device profile 106 is implemented as a neural network, where the inputs to the neural network include data that may impact a calculation of a location, and the hidden bias layers of the neural network include sets of weighted relationships. These weights are determined by sets of data and the relationships may change based on new sets of data.

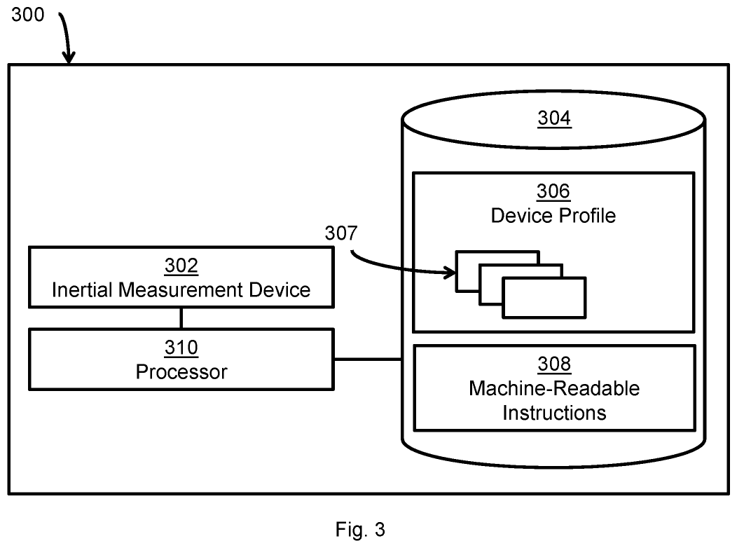

In various examples, the device profile 106 may include information about the electronic device 100 (e.g., date, time, owner), about the location of the electronic device 100 (e.g., availability of network connections, signal strength of network connections, security settings within a designated area, security checkpoints, room schedules, offices occupied), and about a user of the electronic device 100 (e.g., identification, behavior, access rights), or a combination thereof. In this disclosure, any of a variety of information about the location of the electronic device 100 may qualify as location information of the electronic device 100 with the potential exception of a floor plan or ambient lighting conditions of the location, which may be excluded in some examples. In this disclosure, information about a user of the electronic device 100 may be referred to as a “user profile,” as further discussed below in regards to FIG. 3. Thus, the device profile 106 may comprise a user profile. In some examples, the device profile 106 may be installed on the storage device 104 during manufacture of the electronic device 100. In other examples, the device profile 106 may be provided by an owner of the electronic device 100 (e.g., business enterprise, individual user). The machine-readable instructions 108, when executed by the processor 110, cause the processor 110 to perform some or all of the actions attributed herein to the processor 110.

In operation, the processor 110 may receive data from the sensor 102. The data may indicate movement (e.g., orientation, vibration, linear velocity, angular velocity, acceleration, ascent, descent) of the electronic device 100. In this disclosure, such information is called “motion data.” Any of a variety of types of information may qualify as motion data, with the potential exception of GPS data, which in some examples may be excluded. In some examples, the processor 110 may utilize dead reckoning (or similar techniques) to calculate a current location of the electronic device 100 based on the motion data and the device profile 106. By considering the additional data of the device profile 106 in combination with a Kalman filter (or similar technique), the processor 110 may improve the accuracy of the calculated current location by compensating for possible measurement errors (e.g., errors due to noise) captured by the motion data. The processor 110 may additionally calculate an error value based on the calculated current location. The processor 110 may update the device profile 106 based on the calculated error value.

For example, dead reckoning utilizes a previously calculated location (e.g., a location calculated in a time window prior to the current time window) in conjunction with current motion data to calculate a current location based on factors such as speed, elapsed time, direction, etc. However, if an error in measurement occurs due to noise (e.g., dropped laptop, improperly calibrated sensor, electromagnetic interference, poor signal reception), the motion data may include the error. If not corrected, the error is propagated into future measurements. A Kalman filter may be utilized to correct for the error by taking into account an error value determined by comparing the calculated current location and an actual location (e.g., GPS signal). In this manner, the error value is a function of the difference between the calculated current location and the actual location and may be determined by utilizing the squared error function, mean squared error function, or any similar methods. However, in instances where the actual location of the electronic device 100 is unavailable (e.g., within a building with no GPS signal), the error value may rely on other data to represent the actual location of the electronic device 100. This other data may be provided by the device profile 106. For example, the device profile 106 may include information on the location of the electronic device 100 on a certain day of the week at a certain time of the day. The processor 110 may use this information in place of the actual location in the Kalman filter to calculate the error value. The processor 110 may update the device profile 106 based on the error value. In some examples, the device profile 106 comprises a neural network with machine-readable instructions that when executed cause the processor 110 to utilize the error value to determine a bias factor for the information used in place of the actual location in the Kalman filter. If the bias factor indicates the information used in place of the actual location is more reliable, the processor 110 may update the information contained within the device profile 106 to provide the more reliable information, thereby improving the accuracy of future dead reckoning determinations of current locations.

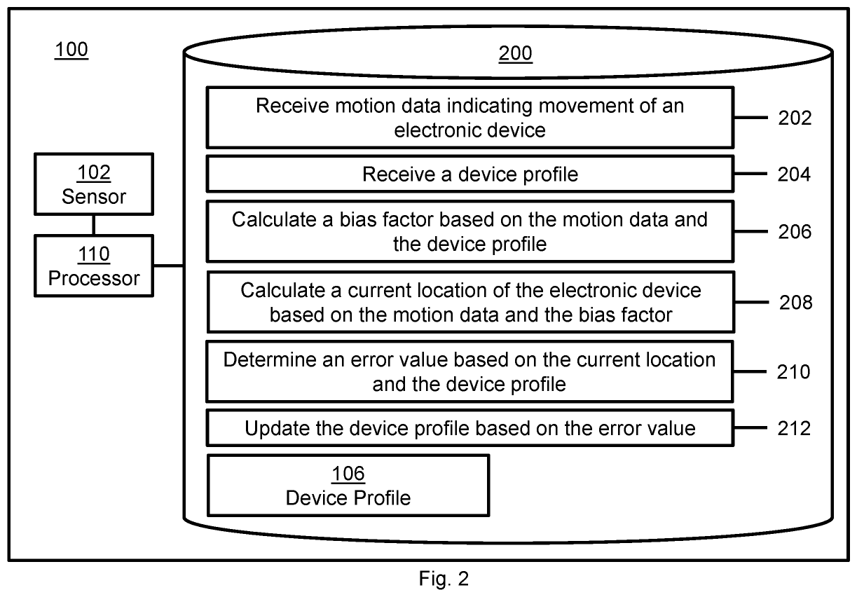

FIG. 2 is a schematic diagram of a computer-readable medium 200 (e.g., storage device 104) storing machine-readable instructions 202, 204, 206, 208, 210, 212 to determine a current location of an electronic device 100, in accordance with various examples. The instructions 202, 204, 206, 208, 210, 212 may be machine-readable instructions for execution by the processor 110 and are illustrative of machine-readable instructions 108. Execution of instruction 202 may cause the processor 110 to receive motion data indicating movement of the electronic device 100. Execution of instruction 204 may cause the processor 110 to receive the device profile 106. Execution of instruction 206 may cause the processor 110 to calculate a bias factor based on the motion data and the device profile 106. Execution of instruction 208 may cause the processor 110 to calculate a current location of the electronic device 100 based on the motion data and the bias factor. Execution of instruction 210 may cause the processor 110 to determine an error value based on the current location and the device profile 106. Execution of instruction 212 may cause the processor 110 to update the device profile 106 based on the error value.

For example, a Kalman filter is a recursive calculation. When the Kalman filter is utilized in dead reckoning determinations of current location, the calculations may account for the reliability of a previously calculated location and previous error estimate as well as noise (e.g., measurement errors) in the motion data. From the previously calculated location and the previous error estimate, a prediction of the current location is made. The prediction of the current location is corrected by adjusting for the reliability of the previously calculated location. The corrected prediction is updated by taking into account the motion data. The current location is determined by adjusting the corrected prediction of the current location for noise in the motion data. An error value is calculated for the current location. (See discussion above with respect to FIG. 1.)

In various examples, a calculated current location for a previous time window and an error estimate associated with the previously calculated current location are utilized to predict a current location. In some examples, the previously calculated current location (e.g., previously calculated location) and associated error estimate (e.g., previously calculated error value) are stored in the device profile 106. The prediction of the current location is corrected by adjusting for the reliability of the previously calculated location. The corrected prediction is updated by taking into account the motion data at the current time window and adjusting for noise in the motion data. In some examples, the device profile 106 comprises a neural network with machine-readable instructions that when executed cause the processor 110 to calculate a bias factor based on the motion data and the device profile 106. The current location is calculated based on the motion data and the calculated bias factor. In other examples, the execution of the machine-readable instructions of the neural network of the device profile 106 cause the processor 110 to determine that a previously calculated bias factor is more reliable than the calculated bias factor. The processor 110 utilizes the previously calculated bias factor in place of the current calculated bias factor in determining the current location. An error value is calculated based on the current location and the device profile 106. The device profile 106 is updated based on the error value. For example, if the error value indicates the current location is more reliable than the previously calculated current location (e.g., a smaller error value), then the processor 110 may update the information contained within the device profile 106 to provide the more reliable information (e.g., bias factor), thereby improving the accuracy of future dead reckoning determinations of current locations.

FIG. 3 is a schematic diagram of an electronic device 300, in accordance with various examples. The electronic device 300 comprises an inertial measurement device 302, a storage device 304, and a processor 310 coupled to the inertial measurement device 302 and the storage device 304. For example, the electronic device 300 may be a laptop computer, a notebook computer, a tablet, a smartphone, a mobile device, or any other suitable device. For example, the processor 310 may comprise a microprocessor, a microcomputer, a microcontroller, or another suitable embedded processor or embedded controller. For example, the inertial measurement device 302 may include an accelerometer, a gyroscope, a magnetometer, an inertial measurement system (IMS), an inertial measurement unit (IMU), another suitable type of inertial measurement device, or a combination thereof. For example, the storage device 304 may include a hard drive, solid state drive (SSD), flash memory, random access memory (RAM), or any other suitable type of memory. The storage device 304 may include machine-readable instructions 308 and a device profile 306 comprising user profiles 307 usable to model user behavior.

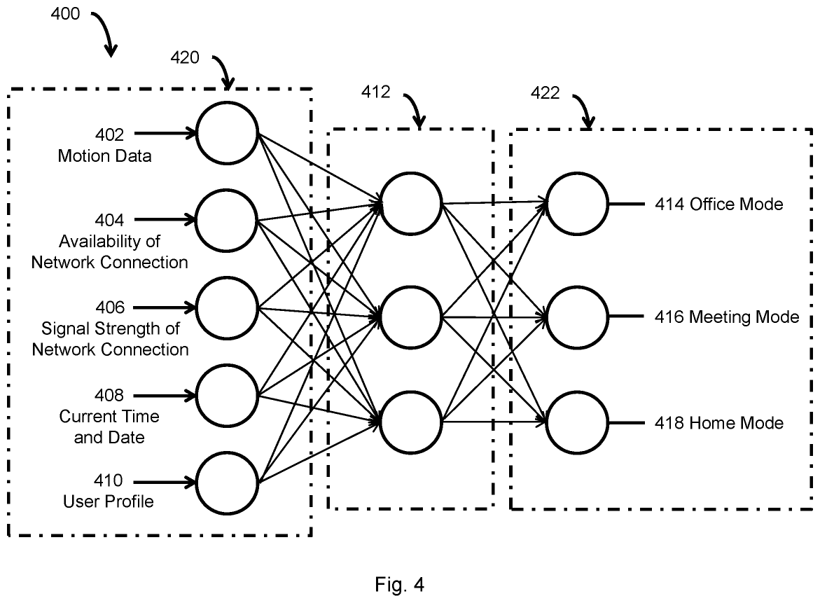

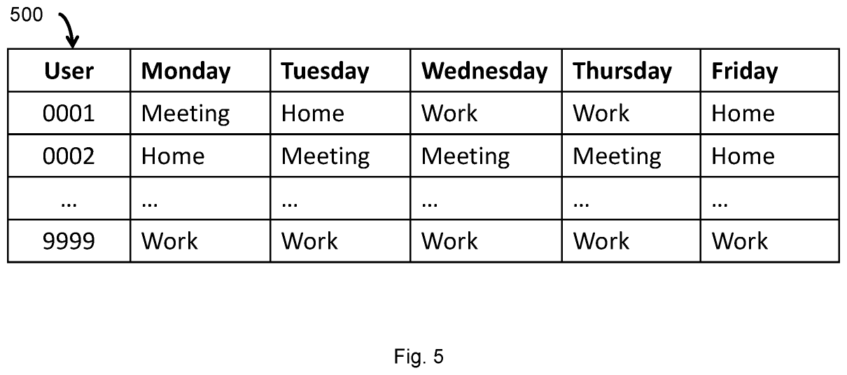

In various examples, the electronic device 300 is a shared device with multiple users (e.g., a computer in a classroom, a tablet in a physician's office, a point of sale unit in a retail business). The user profiles 307 may comprise any of a variety of types of information usable to model user behaviors of the multiple users. For example, a user profile 307 may include information such as what days of the week a particular user goes to work, goes to school, or stays at home; what time of day a user eats, exercises, works, or watches videos; or at what time of day a user passes security checkpoints, utilizes a network connection, or executes an application on an electronic device. Any of a variety of types of information may qualify as information of the user profile 307 with the potential exception of a gait of the user, a stride of the user, or a usual method the user has of carrying the electronic device 300, which in some examples may be excluded. In some examples, the user profile 307 may be installed on the storage device 304 during manufacture of the electronic device 300. The user profile 307 may be provided by an owner or user of the electronic device 300 in some instances. In further examples, the user profile 307 may be updated by the processor 310 utilizing machine learning such as a neural network (or similar method). For example, a user may log into the electronic device 300 at a certain time on certain days of the week or attend a meeting at a certain time of a certain day on a weekly basis. The execution of the machine-readable instructions of the neural network may cause the processor 310 to learn such behavior and incorporate this learned behavior into the user profile 307. Information of the user profile 307 may be analyzed utilizing machine learning such as a neural network (or similar method) to build a user behavior regarding the user's work habits (e.g., daily work hours, work week days, applications utilized, when applications are utilized, offices used, when offices are utilized), meeting habits (e.g., weekly meetings, monthly meetings, applications utilized, when applications are utilized, meeting rooms used, when meeting rooms utilized), or home habits (e.g., at home hours, at home days, applications utilized, when applications are utilized). In some examples, the processor 310 may determine a single user behavior for each day of a work week, as discussed below with regard to FIG. 5. In other examples, the processor 310 may determine a multi-layer user behavior for each day that classifies the behavior into categories based on time of day (e.g., breakfast, lunch, dinner, business hours), day of the week, day of the month, or any category during which the user engages in activities on a regular basis. In yet other examples, the processor 310 may determine a path comprising destinations (e.g., office, meeting room, home, restroom, cafeteria, restaurants, dry cleaners, grocery store) and routes a user travels between each destination during a certain time period (e.g., day, week, month, workday, weekend). The processor 310 may determine a user mode of the electronic device 300 based on the user behavior (e.g., work habits, meeting habits, home habits), as discussed below with regard to FIG. 4. The machine-readable instructions 308, when executed by the processor 310, cause the processor 310 to perform some or all of the actions attributed herein to the processor 310.

In operation, the processor 310 may receive data from the inertial measurement device 302 associated with the electronic device 300. The data may indicate movement (e.g., acceleration, tilt, vibration, angular velocity, ascent, descent) of the electronic device 300. In this disclosure, such information may be called “inertial data.” Any of a variety of types of information may qualify as inertial data, with the potential exception of GPS, which in some examples may be excluded. Utilizing a Kalman filter, as discussed above in regards to FIGS. 1 and 2, the processor 310 may calculate a current location of the electronic device 300 based on the inertial data. The processor 310 may calculate an error value based on the current location and the device profile 306 utilizing the method discussed above in regards to FIG. 1. The processor 310 may update the device profile 306 based on the error value, as discussed above in regards to FIGS. 1 and 2.

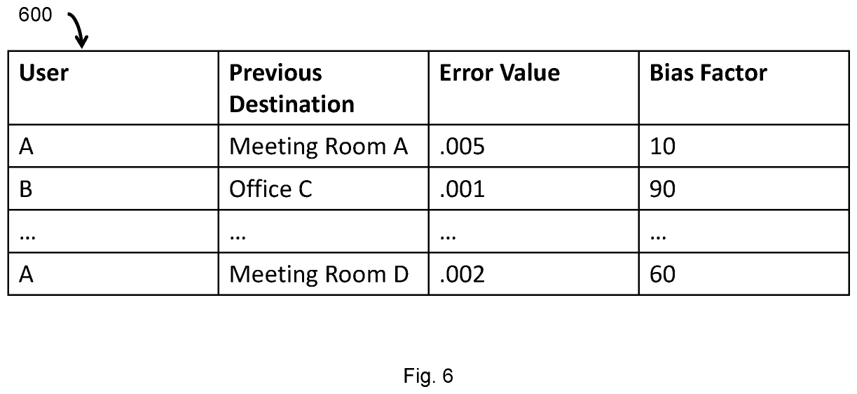

In some examples, the processor 310 may select a user from the user profiles 307 based on the current location and the error value and determine a destination of the electronic device 300 based on the selected user. The user profiles 307 may comprise information on the past destinations and routes of individual users at days and times similar to the current day and time. Utilizing the method discussed above with regard to FIG. 1, the processor 310 may determine an error value based on the current location and past destinations or routes of the individual users. Based on the calculated error values, the processor 310 may determine an individual user is the selected user. (For an example, refer to the discussion of FIG. 6.) In other examples, the processor 310 may prompt a user to verify the selected user. The processor 310 may utilize cross-validation to verify the destination in other instances. For example, if the processor 310 determines that the destination is a meeting room, then the processor 310 may access a calendar associated with the selected user and verify that the selected user has a meeting scheduled in the meeting room. In other examples, the processor 310 may access the user profile 307 of the selected user to verify that she has a user behavior of regularly attending a meeting in the meeting room on certain dates and at certain times. In further examples, the processor 310 determines the destination of the electronic device 300 based on the current location and the selected user. The user profile 307 of the selected user may comprise information on her past destinations on similar days or times to the current day or time. For example, if the current day is Tuesday, the processor 310 may compare the current location to destinations of the selected user on past Tuesdays and determine a destination.

FIG. 4 is a conceptual diagram of a device profile 400 of an electronic device 100, 300, in accordance with various examples. The device profile 400 comprises inputs 420, bias factors 412, and outputs 422. The inputs 420 may include information about the electronic device 100, 300 (e.g., current date and time 408, owner), about the location of the electronic device 100, 300 (e.g., availability of network connections 404, signal strength of network connection 406, security settings within a designated area, security checkpoints), about a user profile 410 of the electronic device 100, 300, and motion data 402 of the electronic device 100, 300, or a combination thereof. The outputs 422 may include information about a user mode (e.g., office mode 414, meeting mode 416, home mode 418).

In various examples, the device profile 106 comprises a neural network with machine-readable instructions that when executed cause the processor 110 to determine the bias factors 412. A bias factor 412 may be calculated based on one input 420 or a selection of inputs 420. Each bias factor 412 is calculated based on a different combination of inputs 420. The number of bias factors 412 is determined by a number of inputs, a number of bias layers, and a number of outputs desired. For example, a first bias layer may account for the inputs 420. Outputs of the first bias layer may become inputs to a second bias layer. A bias factor 412 in the second bias layer may be calculated based on one output of the first bias layer or a selection of outputs of the second bias layer. In this manner, the bias layers may refine the calculations until the number of outputs is achieved. The processor 110 determines a bias factor 412 by adjusting a weight associated with the input 420 and the bias factor 412. The weight may be adjusted based on an error value calculated after utilizing an input 420 from the device profile 106 in a calculation. For example, if a previous destination is used as an actual location in a dead reckoning method, the resulting error value may be utilized to update the weight of any bias factor 412 with an input 420 of a previous destination. In some examples, a lower error value may indicate a more reliable calculation and the weight between any bias factor 412 with an input 420 of a previous destination may increase to indicate the relationship is more trustworthy (e.g., more accurate, more reliable) than other input-bias factor relationships. (See discussion above with regard to FIGS. 1, 2, and 3.) An output 422 is calculated based on one bias factor 412 or a selection of bias factors 412. Each output 422 is calculated based on a different combination of bias factors 412. The processor determines an output 422 based on a weight associated with the bias factor 412 and the output 422. The weight may be adjusted based on an error value calculated after utilizing an input 420 from the device profile 106 in a calculation. Utilizing the previous example in which a previous destination is used as an actual location and a lower error value resulted, the weight of any output 422 with a bias factor 412 with an input 420 of a previous destination may also increase to indicate the relationship is more trustworthy (e.g., more accurate, more reliable) than other bias factor-output relationships.

In various examples, the output 422 of the device profile 400 is a user mode. The processor 310 may utilize the user mode to determine a configuration of the electronic device (e.g. applications accessible, security settings). An office mode 414 may indicate a user is located in a workplace and has access rights associated with the workplace. A meeting mode 416 may indicate a user is located in a meeting room and has access rights associated with meetings. A home mode 418 may indicate a user is located in a residential location and has access rights associated with the residential location. The user mode may be established by a variety of methods (e.g., user input, system architect design, security settings). In some examples, a behavior of the user (e.g., working, taking notes, watching a movie, inactive) may indicate the user mode (e.g., office mode 414, meeting mode 416, school mode, home mode 418). In other examples, the processor 110, 310 may determine that the user mode is an office mode 414, a meeting mode 416, or a home mode 418 based on the current location of the electronic device 100, 300. For example, the processor 110, 310 may determine that the user is in a residential building (e.g., an apartment, a condo, a house). Based on the current location, the processor 110, 310 may determine a user mode of home mode 418. In some instances, the processor 110, 310 may restrict a user's access rights to certain applications or to the electronic device 100, 300 based on the user mode. For example, when the user mode is home mode 418, an enterprise owner of the electronic device 100, 300 may include in the device profile 400 that certain applications are not accessible in home mode 418 (e.g., proprietary applications of the enterprise, applications to access secured enterprise information). In other instances, the processor 110, 310 may restrict a user's access rights after determining a behavior of the user fails to conform to the current location. For example, the current location may indicate the user has deviated from a particular route of the user by an unacceptable threshold. The processor 110, 310 may restrict access to the electronic device 100, 300 until the user verifies security credentials or returns to the particular route. The processor 110, 310 may prompt a user to verify the user mode in various examples. In further examples, the processor 110, 310 may execute an application of the electronic device 100, 300 based on the selected user mode. In some examples, the user mode of the device profile 400 may assist the processor 110, 310 to navigate a user to an available meeting room or office space based on information about the current location of the electronic device 100, 300. For instance, the user mode of the device profile 400 may indicate a meeting mode 416. The processor 110, 310 may access information about the current location of the electronic device 100, 300 and allow the user to select from a list of available meeting rooms. In another example, the user mode of the device profile 400 may indicate an office mode 414. The processor 110, 310 may access information about the current location of the electronic device 100, 300 and allow the user to select from a list of available offices (e.g., agile work environment, office sharing environment).

FIG. 5 depicts a lookup table 500 of user profiles that may be stored in a device profile 106, 306, 400 of an electronic device 100, 300, in accordance with various examples. The lookup table 500 may be part of a data structure or neural network stored in memory that is part of main memory or long-term memory of the electronic device 100, 300, such as SSD, RAM, or flash memory. In some instances, the user profiles may be associated with a user mode (e.g., meeting, home, work) based on the current day of the electronic device 100, 300. For example, in the lookup table 500, on Monday, a first user 0001 is associated with a user mode of meeting mode, a second user 0002 is associated with a user mode of meeting mode and another user 9999 is associated with a work mode. Upon determining a current day of Monday and determining a current location, the processor 110, 310 may determine that the first user 0001 has possession of the electronic device 100, 300 and use the lookup table 500 to determine the user mode is meeting mode. This determination may happen on different days. In some instances, the processor may further prompt the user to verify she is the first user 0001. In other instances, the processor 110, 310 may prompt the user to verify the meeting mode. The processor 110, 310 may execute an application (e.g., PowerPoint, Notepad, Word) based on the user mode (e.g., meeting mode).

FIG. 6 depicts a lookup table 600 that may be stored in a device profile 106, 306, 400 of an electronic device 100, 300, in accordance with various examples. The lookup table 600 may be part of a data structure and may be inputs into a neural network. Both the data structure and the neural network may be stored in memory that is part of main memory or long-term memory of the electronic device 100, 300, such as SSD, RAM, or flash memory. The lookup table 600 may contain information about a user, her previous destination, an error value associated with the calculation, and a bias factor associated with the user, previous destination, and error value. In some instances, a higher bias factor indicates a more reliable prediction of current location based on the previous destination. In other instances, a lower error value indicates a more reliable prediction of current location based on the previous destination. The bias factor may be based on the corresponding error value, or may be determined independently of the error value. The error value may be based on the bias factor, or may be determined independently of the bias factor. As an example, in the lookup table 600, a user profile A (belonging to a first user) may be associated with a previous destination of Meeting Room A with an error value of 0.005 and a bias factor of 10 and a previous second destination of Meeting Room D with an error value of 0.002 and a bias factor of 60. A user profile B (belonging to a second user) may be associated with a previous destination of Office C with an error value of 0.001 and a bias factor of 90. Upon determining a current location of the electronic device 100, 300, the processor 110, 310 may determine that the user of the electronic device 100, 300 is the user A. For example, the current location may be further away from Office C and not on a route associated with user B to Office C, so the processor may determine that the user is more likely to be user A. The processor 110, 310 may determine based on the current location, error value, and bias factor that the first user A is destined for Meeting Room D. For example, the current location may be closer to Meeting Room A, but the higher error value may indicate that user A often passes by Meeting Room A on a route to another destination, such as Meeting Room D. The processor 110, 310 may further determine based on the current location and bias factor that user A is destined for Meeting Room D because the bias factor associated with Meeting Room D is higher. In some instances, the processor 110, 310 may prompt the user to verify she is user A. In other instances, the processor 110, 310 may prompt the user to verify she is destined for Meeting Room D. The processor 110, 310 may validate that user A is destined for Meeting Room D by accessing user A's calendar on the electronic device 100, 300 in other examples. In further examples, the processor 110, 310 may determine that the user mode should be the meeting mode. The processor 110, 310 may execute an application of the electronic device 100, 300 based on the meeting mode (e.g., PowerPoint, Notepad, Word).

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. An electronic device, comprising:
a sensor to output motion data indicating movement of the electronic device;
a storage device storing a device profile; and
a processor coupled to the sensor and the storage device, the processor to:
receive the motion data;
calculate a current location of the electronic device based on the motion data and the device profile;
calculate an error value based on the current location; and
update the device profile based on the error value.

2. The electronic device of claim 1, wherein the sensor is an accelerometer, an inertial measurement device, a gyroscope, and a global positioning system (GPS), or a combination thereof.

3. The electronic device of claim 1, wherein the device profile comprises an availability of network connections, a signal strength of a network connection, a current time and date, and a user profile specifying a user behavior, or a combination thereof.

4. The electronic device of claim 1, wherein the device profile comprises a data structure of previously calculated locations and previously calculated error values.

5. The electronic device of claim 4, wherein the device profile comprises a data structure of weighted values based on the previously calculated locations and the previously calculated error values.

6. A non-transitory computer-readable medium to store machine-readable instructions that, when executed by a processor of an electronic device, cause the processor to:
receive motion data indicating movement of the electronic device;
receive a device profile;
calculate a bias factor based on the motion data and the device profile;
calculate a current location of the electronic device based on the motion data and the bias factor;
determine an error value based on the current location and the device profile; and
update the device profile based on the error value.

7. The computer-readable medium of claim 6, wherein the machine-readable instructions cause the processor to determine a user mode of the electronic device based on the current location.

8. The computer-readable medium of claim 7, wherein the machine-readable instructions cause the processor to determine that the user mode is an office mode, a meeting mode, or a home mode.

9. The computer-readable medium of claim 8, wherein the machine-readable instructions cause the processor to prompt a user to verify the user mode.

10. The computer-readable medium of claim 7, wherein the machine-readable instructions cause the processor to execute an application of the electronic device based on the user mode.

11. An electronic device, comprising:
an inertial measurement device to output inertial data pertaining to the electronic device;
a storage device comprising a device profile usable to model a user behavior, the device profile comprising multiple user profiles; and
a processor coupled to the inertial measurement device and the storage device, the processor to:
receive the inertial data;
calculate a current location of the electronic device based on the inertial data;
calculate an error value based on the location and the device profile; and
update the device profile based on the error value.

12. The electronic device of claim 11, wherein the processor is to select a user from the multiple user profiles based on the current location and the error value, and wherein the processor is to determine a destination of the electronic device based on the selected user.

13. The electronic device of claim 12, wherein the processor is to prompt a user to verify the user selection.

14. The electronic device of claim 12, wherein the processor is to determine the destination of the electronic device based on the current location and the selected user.

15. The electronic device of claim 14, wherein the processor is to configure an access rights setting based on the selected user.
